(19) United States
(12) Patent Application Publication
(10) Pub. No.: US 2004/0201602 A1
(43) Pub. Date: Oct. 14, 2004

(54) Tablet computer system for industrial process design, supervisory control, and data management

(75) Inventors: Rashesh C. Mody, San Clemente, CA (US); Guruprasad Y.P. Rao, Lake Forest, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Invensys Systems, Inc., Foxboro, MA (US)

(21) Appl. No.: 10/680,542

(22) Filed: Oct. 7, 2003

Related U.S. Application Data
(60) Provisional application No. 60/462,671, filed on Apr. 14, 2003.

(51) Int. Cl. G09G 5/00

(52) U.S. Cl. 345/700

(57) ABSTRACT

A tablet PC for industrial/manufacturing process control and data management is disclosed. The tablet PC includes one or more industrial/manufacturing process control and data management applications as well as a set of hardware/software capabilities including wireless network access, screen capture/annotation, electronic pen/stylus input, handwriting input panel and recognition, camera, data snapshot capture, email, barcode/RF reader, etc. The combination of enhancements to the software and hardware embodied within the disclosed tablet PC for industrial process control and data management provide a variety of new uses for a PC in an industrial environment.

### CROSS REFERENCE TO RELATED APPLICATIONS

This application claims priority of Mody, U.S. provisional application Serial No. 60/462,671 filed on Apr. 14, 2003, entitled “A Tablet Computer System for Manufacturing Information and Supervisory Process Control” the contents of which is expressly incorporated herein by reference in its entirety including the contents and teachings of any references contained therein.

### FIELD OF THE INVENTION

This invention generally relates to the area of industrial process design control, and information management systems. More particularly, the present invention concerns methods and systems for designing, configuring and managing manufacturing/industrial processes comprising both individual and grouped components that make up the overall industrial processes. The invention also pertains to systems that use the production information rendered by such industrial/manufacturing processes. More specifically, the present invention relates to methods and systems that include human/machine interfaces that provide views of information relating to manufacturing/industrial processes for a variety of design, control and information management purposes.

### BACKGROUND OF THE INVENTION

Computer systems are utilized for the design, configuration, and/or management of manufacturing/industrial processes and managing information generated by such processes. The process control/management computer systems are utilized for a variety of purposes including: enterprise management, production management, and factory automation and control. Each of these three areas potentially addresses different market segments and vertical solutions. For example, factory automation and control components include human-machine interface software, distributed control systems, hardware, control, batch, quality, asset management software, etc. Enterprise management includes ERP—enterprise resource planning, CRM—customer relationship management, and storage software. Production management includes MES—manufacturing execution systems, resource management, supply chain, data warehouse management components.

Computer systems utilized in association with industrial processes are typically placed in a large number of locations within a plant as well as off site. The computer systems are generally specialized and can be classified by their intended use. One class of computer system is located within control rooms generally located remotely from the actual processes/control equipment. The remotely located computers are monitored by operators in a relatively clean, climate-controlled environment. Such computer systems need not be specifically protected from moisture, dust, extreme swings in temperature, etc. Furthermore, a relatively small number of computer systems of the above-described class generally receive information from, and provide control instructions to, a large number of distributed equipment modules that carry out a controlled industrial/manufacturing process. A subclass of the above-described computer system class utilizes the information rendered by the industrial/manufacturing control system to perform higher level, enterprise and production, management tasks (e.g., CRM, ERP, etc.).

Another class of computer system, utilized particularly to configure and manage processes, is located on the plant floor. Such computer systems are placed near actual controlled process equipment/systems to enable an operator to observe the actual process/equipment while at the same time noting/changing the state of the process control system (e.g., process variables, set points, etc.). The plant floor computer systems are provided at considerable cost to the owner/user. Not only are a large number of such systems required (one for each equipment module for which direct observation is desired), the plant floor equipment requires special housings/interfaces that resist dust, moisture, extreme temperatures, etc. Notwithstanding such additional protection, the plant floor systems will likely incur higher maintenance costs in view of the potentially harsh operating environment. Furthermore, the plant floor systems must include suitable security/authentication mechanisms to ensure that each class of user is provided only the authorized level of access to industrial process system resources to which the particular user is entitled. Some applications, e.g., configurators, should only be executed by a particular class of engineers. Ensuring such restrictions increases system complexity.

However, the absence of the plant floor computer systems would pose a significant burden upon engineers and operators of the process control system to carry out the configuration and operation of the controlled industrial/manufacturing processes. For example, in the absence of a plant floor configuration/control system, an engineer on the plant floor would have to issue requests to another engineer at a remote control terminal. The engineer at the remote control terminal carries out the request, and the engineer on the plant floor observes the actual response of the system to the request (e.g., a tank ceases leaking in response to a reduced fluid level). In view of the added difficulties in observing and changing controlled processes without actually being in the presence of the controlled equipment, most controlled industrial processes include such environmentally protected systems dispersed at many locations within a plant.

### SUMMARY OF THE INVENTION

A tablet PC for industrial process design, control and data management is addresses a number of shortcomings present in the above-described known systems by providing a highly mobile, powerful, and flexible platform upon which a broad spectrum of applications reside. The tablet PC, due to its mobility, becomes a “personal” computing station that can be moved by its assigned user(s) from station to station within a plant—as opposed to a location-centric non-mobile known user station that is generally tied to a particular location/station within a plant.

In accordance with the present invention a tablet personal computer system is configured with a set of services and application software that facilitate performing a variety of design, supervisory and/or data management tasks associated with industrial processes. The tablet personal computer includes a human-machine interface integrated into a tablet personal computer that facilitates presentation of industrial process control system related information including views of industrial processes as well as production information arising from the industrial processes. A wireless communication resource is incorporated into the tablet PC that enables a user to link into a process area network and the multitude of design, configuration, control, and database resources accessed via the process area network. Finally, a set of one or more tablet PC enabled industrial process applications relating to supervisory control of industrial processes are provided on the tablet PC. The industrial process applications and the services supported by tablet PC enable users to interact with the application programs via the human-machine interface.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is an exemplary network arrangement including . . . wherein an illustrative embodiment of the present invention is advantageously incorporated;

FIG. 2 is a simplified schematic drawing summarizing an exemplary set of functional capabilities incorporated within a tablet PC suitable for carrying out the present invention;

FIG. 3 enumerates an exemplary list of industrial process design, supervisory control and data management usage scenarios supported by the enhanced functional capabilities of the tablet PC schematically depicted in FIG. 2;

FIG. 4 provides an exemplary tablet PC screen view depicting a pen input panel user interface functionality supported by the exemplary tablet PC; and

FIG. 5 provides an exemplary tablet PC screen view depicting an annotation functionality embodied in the tablet PC embodying the present invention.

### DETAILED DESCRIPTION OF THE DRAWINGS

In the illustrative embodiment of the present invention disclosed herein, a tablet PC provides a highly mobile and functionally diverse platform for carrying out a variety of tasks associated with controlling industrial (a.k.a., manufacturing) processes and managing information arising from and/or related to such processes. In particular, the tablet PC comprises, by way of illustrative example, system/application software and hardware supporting a set of functional capabilities including: a pen/stylus interface, handwriting recognition, screen capture/annotation, a camera, a microphone, a barcode/RF tag reader, email, and wireless networking/communication. The exemplary functional capabilities are utilized by one or more applications executed upon the tablet PC for process design, control and information management. The applications exploit one or more of the above identified functional capabilities to support a variety of workplace tasks/usages.

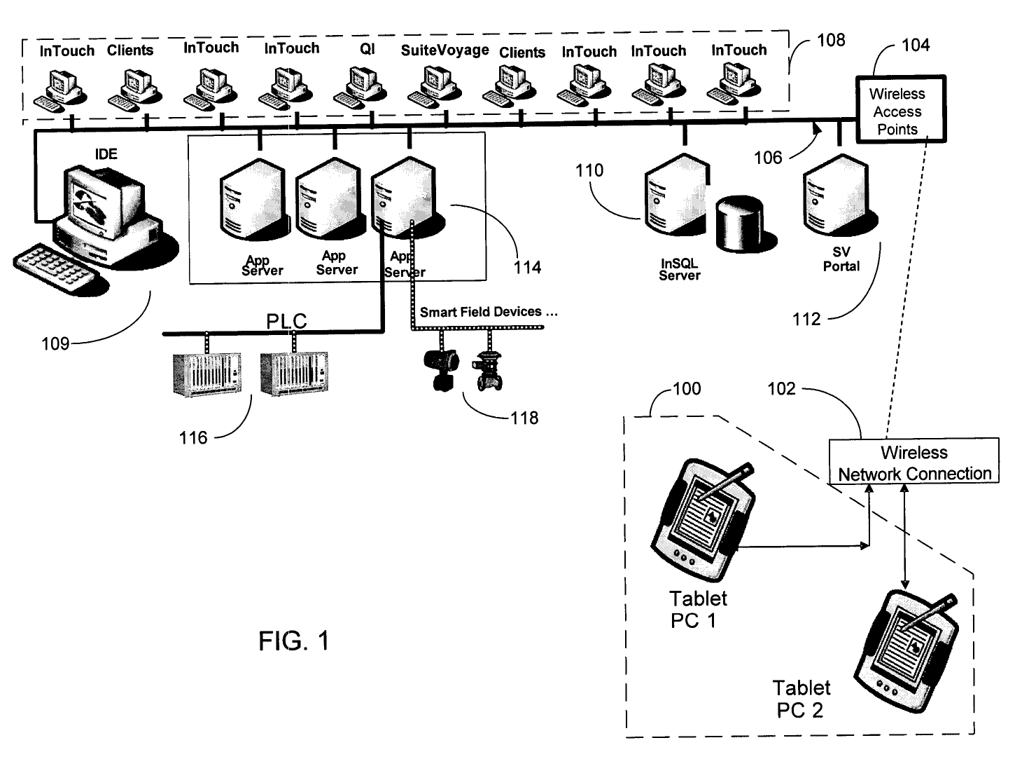

Turning initially to FIG. 1, an exemplary industrial/manufacturing environment is illustratively depicted for utilization of a tablet PC specifically configured with a combination of functional capabilities and applications for use in an industrial process design, control, and/or data management. The tablet PC, in general, is a wireless-network capable personal computer wherein the primary means of user input is natural handwriting (through a stylus or electronic pen) and pointing on a screen. However, tablet PC's also accommodate keyboard input/editing.

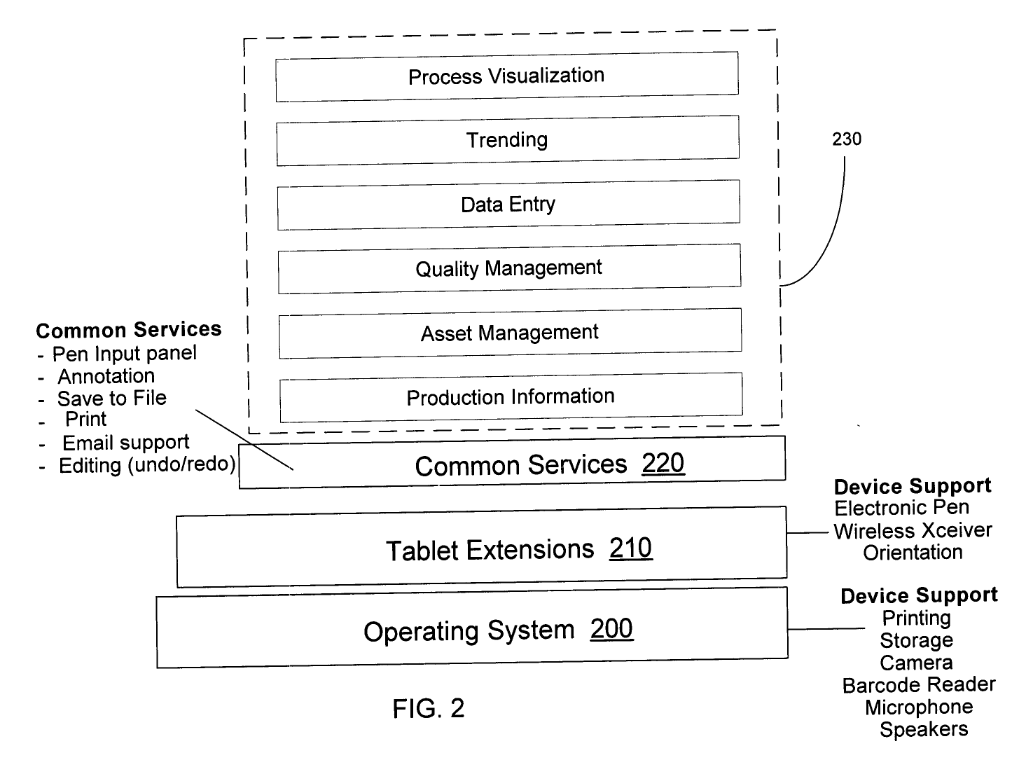

In the illustrative exemplary operating environment for the present invention, a set of industrial process application-rich tablet PCs 100 (described further herein below with reference to FIG. 2) embodying the present invention are linked via wireless network connections 102 to one or more wireless access points 104 on the process area network 106. The connections 102 utilize well known wireless LAN protocols such as 802.11 a/b/g Wi-Fi protocols. However, the present invention contemplates a wide variety of wireless/wired connectivity schemes between the tablet PCs 100 and the process area network 106.

The process area network 106 includes a variety of functional nodes and sub-networks. For example, a set of user stations 108, placed at a variety of locations within a plant, execute a variety of well known applications including, for example:

In Touch—Process visualization

SuiteVoyager—Manufacturing Information Web Portal

QI Analyst—statistical process control

Trend Analysis

An integrated development environment station 109 supports a suite of utilities for designing and configuring a controlled industrial process. The aforementioned client applications, depicted as associated with the set of user stations 108 and IDE station 109, are incorporated onto the highly mobile application platform of the tablet PCs 100.

The illustrative process area network 106 also includes a number of servers. An Industrial SQL (InSQL) database server 110 provides clients access to historized data maintained for the process control network depicted in FIG. 1. A Suite Voyager server 112 provides supports the Suite Voyager manufacturing information portal clients (including those residing on the fixed user stations 108 and the tablet PCs 100). A set of application servers 114 execute a set of industrial process control engine applications that provide high level control instructions for a set of industrial process controllers (e.g., programmable logic controllers 116) and receive and transmit a variety of control information/instructions associated with a set of field devices 118.

Turning to FIG. 2, a schematic drawing identifies a number of functional capabilities/components incorporated into an exemplary tablet PC suitable for carrying out the present invention. An operating system 200, such as MICROSOFT's WINDOWS XP Tablet PC provides an operating platform upon which the functionality of the present invention is arranged. However, alternative operating systems will be contemplated by alternative embodiments of the invention. The operating system 200 and associated device drivers support a variety of devices including: printers, data storage, cameras (still/video), optical/RF readers, microphones, speakers, etc.

The architecture of the industrial tablet PC for industrial process design, configuration, control and data management also includes a set of tablet-specific extensions 210 including support for an electronic pen/stylus (and associated pen/stylus touch pad) for digital inking support. The exemplary system includes handwriting recognition for converting handwritten input into corresponding alphanumeric symbols (e.g., ASCII text). The tablet extensions 210 also support wireless connectivity (e.g., Wi-Fi) which adds a dimension of mobility to the applications identified in association with the non-mobile fixed user stations 108. The tablet extensions 210 furthermore support landscape/portrait mode view toggling.

A set of common services 220 are provided that constitute an extensible group of pre-programmed utilities (e.g., an industrial application program developer kit) that can be incorporated into a set of applications 230 that are executed upon the table PC. The common services include a pen input panel for the entry/capture of handwritten input. An annotation service, described herein below, captures a current screen view and supports marking up/commenting/highlighting directly on the captured view—even attaching a sound bite. Thereafter, a user exploits any of a number of I/O services to transfer the annotated screen capture to one or more destinations. Examples of such I/O services supported by the exemplary common services 230 include: Saving to a specified file, printing, and emailing (via wireless link). The common services 220 also support a range of edit functions.

The set of applications 230 comprise, by way of example, any of the previously identified client-station-based applications that were previously executed on fixed location computer terminals. However, their functionality is enhanced, in particular, by the ability to transport the computing/communication power of the stationary stations/terminals in a tablet PC system to a variety of locations within a plant and associated business offices. Examples of such industrial process applications include:

Process visualization (e.g., WONDERWARE's InTouch)

Trending (e.g., WONDERWARE's InTouch)

Data Entry (e.g., WONDERWARE's InTouch)

Statistical Process Control (e.g., WONDERWARE's QI Analyst)

Asset Management (e.g., Enterprise Asset Management)

Production Information (e.g, MES data, batch data, etc.)

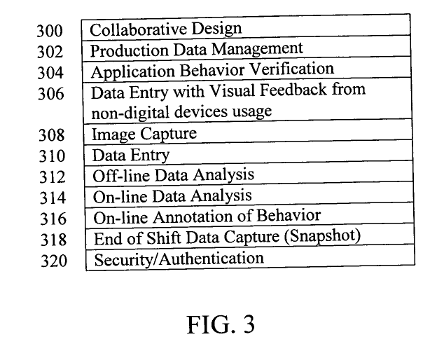

Turning to FIG. 3, an exemplary set of industrial process design, supervisory control, and data management usage scenarios supported by the tablet PC of FIG. 2 are summarized. A Collaborative Design usage 300 supported by the tablet PC enables a reviewer to capture and annotate screens using the electronic pen and screen capture capability of the tablet PC. The annotated captured screens are thereafter placed within a data storage on the network or emailed to a developer of the industrial process control system using the wireless network connectivity feature of the tablet PC. Thus, during a design and development phase of a project, developers use the tablet PC disclosed herein to annotate changes, develop graphics, and track changes to process control designs.

The functional capabilities of the tablet PC are suitable for supporting executing software applications for a Production Management usage 302. The tablet PC disclosed herein is utilized during production meetings, shift reviews and production management applications. The tablet PC supports integrating data from applications (e.g., database programs) developed by a variety of third party software venders. Examples of such applications include: Microsoft Excel, Word, Crystal Reports etc. The tablet PC is thus a highly mobile platform for bringing plant floor data (e.g., real time, historical, etc.) to an electronic clipboard that can be transported to a variety of locations including a plant floor and a conference room.

The tablet PC's functional capabilities also support an Application Behavior Verification usage 304. In this mode of usage, the tablet PC includes application software enabling a developer to verify that an aspect of his/her design (e.g., animation logic) is correct. For example, the developer physically visits equipment that is the subject of depicted animation behavior of a user interface. The developer changes the state of the equipment (e.g., on/off) and observes its actual state as well as the state reflected on an animated display element provided by a graphical user interface screen (e.g., green element for on, red element for off). As noted before, without a monitor available at the equipment site, such verification is performed by two people using two handsets. The mobile nature of the tablet PC embodying the above described functional capabilities enables an graphical display application developer to deploy the graphical display of interest at the testing site and can interact with the application directly to verify its proper operation. Other types of tests include: verifying connections, trouble shooting, calibrating, etc.

Another important aspect of the proposed combination of software and a tablet PC is a data entry with visual feedback from equipment usage 306 wherein a user physically visits plant floor equipment having a mechanical level indicator and puts the value into the system in real time. A benefit of the data entry with visual feedback from equipment usage 306 is the capability of a user to obtain immediate feedback—e.g., that the tank is leaking—by changing an input value and observing its effect on the equipment.

Another aspect of the data entry with visual feedback usage 306 is a user's ability to perform on-location control of production equipment. The tablet PC, in this usage mode, operates as a mobile control station wherein a user, through an interface of the tablet PC, controls devices while moving throughout a plant floor and visiting various equipment stations controllable by a software application loaded onto the tablet PC. The tablet PC communicates control instructions entered by the user via the wireless transceiver incorporated within tablet PC. The user/operator may need to quickly take some process off line to correct a fault condition that the operator physically observes while making visually inspecting the plant equipment (e.g., such as a faulty valve spewing liquid). It may be too late to wait until the operator gets back to the control room. Additional components of the tablet PC that may play a part in the data entry usage 306 are barcode and RF ID readers that read a piece of equipment's identification and initiate launching a control interface for the particular equipment on the tablet PC.

Another task supported by the tablet PC comprises an image capture task 308. In this usage mode (and an online annotation usage 316 described below), the Tablet PC, equipped with a camera (still/video) and annotation software, captures an image, accepts voice or text input (via pen or keyboard), and sends the annotated image to a selected destination (e.g. email address). For example, a digital camera captures an image of a rusted tank, the user circles the rust on the captured image using the electronic pen/stylus, adds voice commentary (E.g., notice the rust on the bottom of the tank). The receiver opens the email and the annotated image is displayed and the recorded voice is played.

Yet another task executed by a tablet PC for industrial process control environments is a database data entry task 310. A data warehousing application and other plant/process automation software is installed and executed upon the tablet PC depicted in FIG. 2. As such the tablet PC is capable of supporting a database data entry task 310 for entering data, modifying data, and reviewing results. The database data entry task 310 is potentially used by quality control personnel to review results and measurements. The tablet PC supports applications that incorporate the database data entry task 310 through the barcode and RF reader capabilities.

In an Off-line data analysis use 312, the tablet PC facilitates performing off-line analysis of data. For example, a user, through the tablet PC, acquires data from a database supported by an industrial control database such as IndustrialSQL and analyzes and annotates the information offline. Examples of such off-line analyses include: trending, down time analysis, statistical process control/statistical quality control (SPC/SQC) analysis.

Similarly, an On-line data analysis use 314 supports capturing data as it is generated (e.g., acquiring a stream of process data from IndustrialSQL). In a particular usage, the tablet PC performs off line entry of data with later sync-up. The exemplary tablet PC also includes a “whiteboard” application with chat capabilities built in to enable participants to edit/view the contents of the “whiteboard.” The tablet PC also supports online annotation of behavior. In an online annotation usage 316, the tablet PC captures real time information and annotates the snap-shot with added comments to show someone else later. Furthermore, the tablet PC supports applications facilitating an end of shift snapshot usage 318 that captures what has occurred over the course of a shift. Examples of such functionality include production period reports, summaries of data entered during the course of a day.

A final usage supported by the tablet PC is a security and authentication usage 320. The electronic pen/stylus supports handwritten signatures on reports—a second level of authentication. In other applications, the handwritten input is used for bio-metric digital signature and authentication. The signature input is also used in Food and Drug Administration (FDA) validation, tracking and process changes.

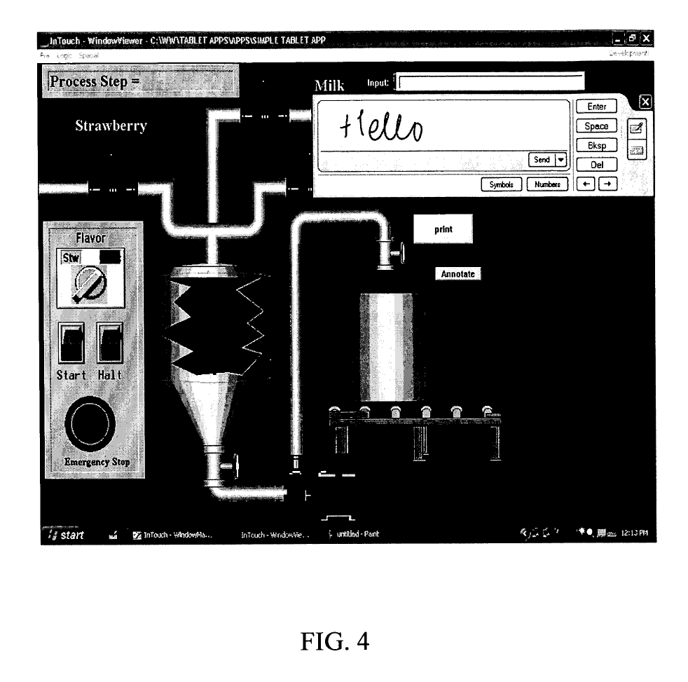

Having described a set of usages provided by applications supported by the tablet PC embodying the present invention, attention is directed to the input panel and annotation capabilities supported by the tablet PC embodying the present invention. First, with reference to FIG. 4, an exemplary graphical user interface is provided that includes a pen input panel (in the upper right corner). The pen input panel is popped up when the input touch link edit box is displayed. The edit box is displayed, for example, by WONDERWARE's InTouch Runtime (view) application when a user selects an input link. A Pen Input Panel object, corresponding to the displayed input panel displaying a handwritten “Hello,” enables applications to specify in-place pen input functionality. The Pen Input Panel object is available as an attachable object that allows application developers to add tablet PC pen input panel functionality to existing controls. It is noted that the pen input panel is replaced/augmented by speech input/recognition functionality.

In the illustrative example set forth in FIG. 4, edit boxes are displayed by an InTouch Window Viewer when a tag is configured as a Touch Link of type “Analog” and “Message.” The edit boxes are enhanced so that when a View is running on the Windows Tablet PC Version it will display a pen input panel in addition to the edit box. In an embodiment of the invention, the edit box is displayed only when the Keypad option is set to “No.” The pen input panel includes a set of basic supplemental function blocks for manipulating a cursor, deleting characters, displaying/selecting numbers and symbols, entering a string of input, and sending a selected view to a designated destination. The default input method for the Pen Input Panel object is handwriting. However a user can switch between handwriting and keyboard input methods using buttons on the graphical/electronic pen-sensitive user interface of the tablet PC. A send button on the pen input panel, when selected, initiates translation/transformation of handwritten input into text character input that is displayed within an edit box (displayed above the pen input panel).

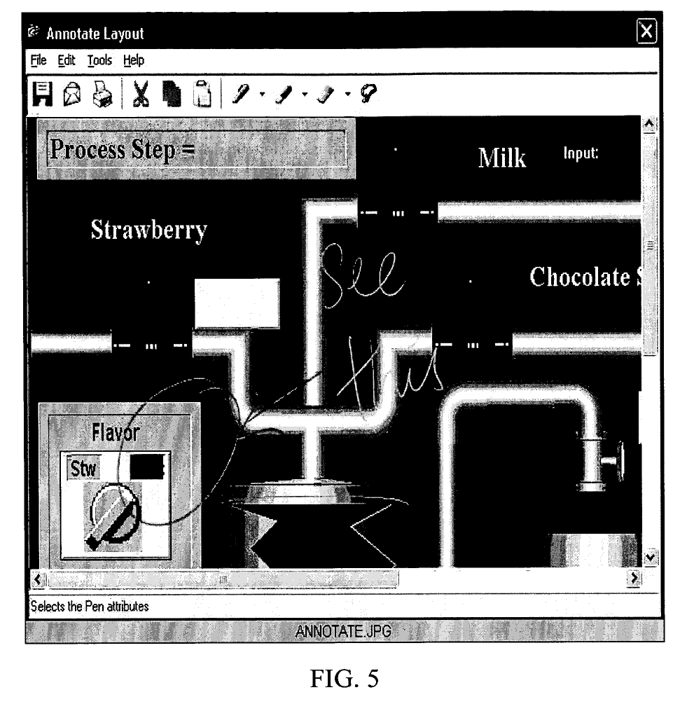

Turning to FIG. 5, another particularly valuable capability of the industrial process design, control and data management tablet PC embodying the present invention is view/layout annotation. The annotation capability works in conjunction with other capabilities to enable a user to capture a view, comment and mark it up (including adding voice annotations), and send the resulting image to a designated destination. In order to support this additional capability, in an embodiment of the present invention, a script function called “AnnotateLayout” is introduced into a viewer application (e.g., WONDERWARE's InTouch). The AnnotateLayout script function allows a user to annotate a current view screen as it stands when the AnnotateLayout script is invoked. The AnnotateLayout script pops up a dialog of the type depicted in FIG. 5. In the illustrative example, the dialog facilitates performing the following list of operations:

Capturing the screen image of a view at the time the dialog is invoked;

Allowing annotation on the screen capture (using tool bar/menu items);

Allowing the image and the annotation to be saved as an image (e.g., GIF or JPEG) file;

Allowing the image and the annotation to be printed (if a printer is configured) and

Allowing the image and the annotation to be sent as an attachment in an e-mail (if email is available/enabled on the wireless network to which the tablet PC is connectable).

In the illustrative example of an annotation interface set forth in FIG. 5, the PC tablet display includes a toolbar and menu items and it shows a captured screen view in its client area. The user can annotate the image using the electronic pen.

The toolbars (on the top right and bottom middle of the display) consists of: Save, E-Mail, Print, Cut, Copy, Paste, Pen, Highlighter, Eraser and Lasso. The Save option saves the image and annotation as an image data (e.g., GIF, JPEG, etc.) file. An E-Mail option pops up a dialog box with minimal functionality of “To”, “Cc”, “Subject”, “Attachment” and “Message” text boxes and a “Send” button. If email is not enabled (e.g., SMTP is not configured) the email toolbar item is disabled. A Print option pops up a standard “Print” dialog and prints the annotated image to a selected printer. If no printer has been configured then this toolbar option is disabled.

A Pen option on the user interface, when selected, expands to “Color,” “Size,” “Tip” and “Transparency” sub-options Clicking the Color sub-option brings up the standard color picker dialog box for choosing color. The default is Red. Clicking the Size sub-option brings up a Word Style menu item showing different lines from 1 pt to 5 pt thickness. The default is 1 pt. Clicking the Tip sub-option expands to “Ball” and “Rectangle.” The default selection is “Ball.” Depending on the selection a check mark appears on the left side of the menu. Clicking the “Transparency” sub-option brings up a dialog in which the user can select the transparency. The default is “0%.”

A Highlighter option on the user interface, when selected, expands to “Color” and “Transparency” sub-options. Clicking the Color sub-option brings up the standard color picker dialog box for choosing color. The default is Yellow. Clicking the “Transparency” sub-option brings up a dialog in which the user can select the transparency. The default is “50%”.

An Eraser option in the user interface, when selected, expands to “Mode” and “Size” sub-options. The “Mode” sub-option further expands to “Stroke” and “Point.” The default is “Point.” The “Size” sub-option expands to “Small,” “Medium” and “Large.” The default is “Medium.”

A Lasso option selects an area on the captured image for purposes of performing an edit function. The lasso facilitates rubber banding of annotations within a displayed window. When operating in a Lasso mode, a user clicks the pen, selects one or more annotations (by circling the items and then clicking the pen again), and then performs an edit function on the “lassoed” annotations (e.g., delete, cut, copy, etc.)

The graphical display for the annotation view includes a menu including the standard “File”, “Edit”, “Tools” and “Help.” The File menu item expands to “Save”, “E-Mail”, “Print” and “Exit” and the corresponding accelerator keys are Ctrl+S, Ctrl+M, Ctrl+P and Alt+F4, respectively. If the image is dirty, e.g., some annotation is made on the image and then the dialog is closed without saving the annotation, then a warning message prompting the user to save the image is displayed. An Edit menu item, when selected, expands to “Undo”, “Redo”, “Clear”, “Cut”, “Copy” and “Paste.” The Undo sub-option undoes the previous annotation and the accelerator key is Ctrl+Z. A Redo sub-option re-does the previous undone annotation and the accelerator key is Ctrl+Y. The clear sub-option clears all the annotations in the image. A cut option cuts the annotation described by the lasso. Accelerator key is Ctrl+X. A copy sub-option copies the annotation described by the lasso and the accelerator key is Ctrl+C. A paste sub-option pastes copied/cut data in the current window and the accelerator key is Ctrl+V.

In an embodiment of the invention, the annotation window includes a Tools option. The Tools menu item expands to “Pen”, “Highlighter”, “Eraser”, “Lasso” and “Restore Defaults”. The Restore Defaults option, not previously described above, resets all the tools viz. Pen, Eraser and Highlighter to their defaults. A Help menu item expands to “About” and this shows the about dialog box.

The following is an exemplary sequence of actions taken by a user of the above-described annotation functionality incorporated into the illustrative embodiment of the invention. In the examples that follow, a screen capture is created, saved, edited and printed. The user takes a screen capture of a process window, and subsequently annotates, saves and sends the annotated image via email. In the examples that follow, it is assumed that a visualization application (e.g., WONDERWARE's InTouch industrial process visualization) is installed and executing upon a tablet PC configured with the MICROSOFT XP Tablet PC operating system. The window has been configured in InTouch, and the window has an interface resource access button associated with the “annotate” capability, which has been configured to call the script function “AnnotateLayout” service on the tablet PC.

In a first scenario supported by the tablet PC a user annotates a currently displayed window. By way of example, an image of a tank has been created and it is showing the value of a tag “fluidlevel”. The user initially clicks the button “Annotate”. Thereafter, a dialog containing an image of the InTouch Screen pops up. A displayed toolbar consists of Save, E-Mail, Print, Cut, Copy, Paste, Pen, Highlighter, Eraser and Lasso. A menu displays the File, Edit, Tools and Help options (described above).

The user clicks the Pen icon on the toolbar to configure properties of the Pen. The pen toolbar expands to provide a series of options. The user clicks “Color” to activate a standard OS dialog for color picking. The user selects a color for the pen. The user then selects “Size” which expands to show a list of the available line widths ranging from thin (1 pt) to thick (5 pt). The user selects a line width. Next, the user selects “Tip” which expands to a list of tip shapes including “Ball” and “Rectangle.” The user selects one of the tips. Next, the user clicks the “Transparency” option and makes it 50%. This defines the transparency of the pen selected on the image to be drawn.

The user then annotates the image. One form of annotation is highlighting. When the user selects the “Highlighter,” the highlighter option expands to “Color” and the user selects a desired color. The other item defining highlighting is “Transparency”. After setting a transparency level, the user highlights the captured image (undoing highlighting when needed). Thereafter, the highlighted image is saved using the “Save” option on the user interface and saves the file using a standard WINDOWS save dialog box. The saving of annotated images can be stored in a variety of formats including, by way of example, JPEG and GIF file formats.

The annotation mode supports a variety of tools/actions. For example, the user can select an eraser option to remove annotations previously entered on the captured image. A lasso tool enables a user to select a region of annotations and then perform an action on the selected annotation items (cut, copy, delete, etc.).

Yet another use scenario involves emailing an annotated image. In the illustrative example, an SMTP (email) service is configured on the tablet PC. After annotating an image (described above), a user selects a “Send To” option which attaches the annotated image to an e-mail, and a send mail dialog is displayed. The user fills in the necessary information to send it to a particular email recipient and selects a send button to initiate sending the annotated image.

In another use scenario, after annotating an image, a user prints the image. In such case, the printer driver is configured to send the image to a printer on the local area network to which the tablet PC connects via a wireless connection.

It will be appreciated by those skilled in the art that new and useful methods and a tablet PC system for carrying out a variety of industrial process design, control, and data management tasks has been described herein. The present invention comprises a highly portable, powerful, and flexible platform for carrying out a broad variety of usage scenarios associated with industrial processes and managing the products that come from such industrial processes. In view of the many possible environments to which the principles of this invention may be applied, it should be recognized that the embodiments described herein are meant to be illustrative and should not be taken as limiting the scope of invention. Those skilled in the art to which the present invention applies will appreciate that the illustrated embodiments can be modified in arrangement and detail without departing from the spirit of the invention. Therefore, the invention as described herein contemplates all such embodiments as may come within the scope of the following claims and equivalents thereof.

What is claimed is:

1. A tablet personal computer system and software facilitating performing a variety of design, supervisory and/or data management tasks associated with industrial processes including:
a human-machine interface, including a touch-sensitive display region, integrated into a tablet personal computer;
a wireless communication resource; and
a set of one or more application programs relating to supervisory control of industrial processes, wherein the application programs interact with a user via a set of tablet PC interface services associated with the human-machine interface.

2. The tablet personal computer system of claim 1 wherein the human-machine interface includes an electronic pen user interface.

3. The tablet personal computer of claim 2 further comprising handwriting recognition software.

4. The tablet personal computer system of claim 2 further comprising a handwriting input recognition panel.

5. The tablet personal computer system of claim 2 further comprising an annotation functionality enabling capture and annotation, using the electronic pen user interface, of a view displayed on the tablet personal computer.

6. The tablet personal computer system of claim 1 wherein an application program supports collaborative design functionality that enables users to review, edit and annotate a proposed design for industrial process control.

7. The tablet personal computer system of claim 1 wherein the set of applications includes a production management application program supporting access to a set of databases.

8. The tablet personal computer system of claim 1 wherein the set of application programs includes application verification software for confirming proper design logic by setting values and observing statuses of controlled equipment.

9. The tablet personal computer system of claim 1 wherein the set of application programs includes application software enabling data entry for controlling a plant floor device.

10. The tablet personal computer system of claim 1 further comprising an integrated camera, and wherein the set of application programs includes application software supporting capturing an image and further annotating the captured image.

11. The tablet personal computer system of claim 10 wherein the camera is a still image camera.

12. The tablet personal computer system of claim 10 wherein the camera is a video camera.

13. The tablet personal computer system of claim 1 wherein the set of application programs includes application software for receiving data input for entry into a database.

14. The tablet personal computer system of claim 1 wherein the set of application programs includes application software facilitating offline data analysis.

15. The tablet personal computer system of claim 1 wherein the set of application programs includes application software facilitating online data analysis.

16. The tablet personal computer system of claim 1 wherein the set of application programs includes application software incorporating a user interface for selectively capturing and annotating real time information.

17. The tablet personal computer system of claim 1 wherein the set of application programs includes application software for capturing end of shift snapshots.

18. The tablet personal computer system of claim 1 further including user authentication mechanisms.
